(19) United States
(12) Patent Application Publication
(10) Pub. No.: US 2013/0270339 A1
(43) Pub. Date: Oct. 17, 2013

(54) SPECIMEN TUBE LABELING SYSTEM

(71) Applicant: TYPENEX MEDICAL, LLC, Chicago, IL (US)

(72) Inventors: Luke Westra, Chicago, IL (US); Philip M. Anthony, Chicago, IL (US); Evan P. Thompson, Oak Park, IL (US); Aaron Eiger, Chicago, IL (US); David Schwaba, Chicago, IL (US); Kenneth J. Bargo, Chicago, IL (US); David Goldman, Chicago, IL (US); Trevor Wesolowski, Chicago, IL (US)

(21) Appl. No.: 13/862,041

(22) Filed: Apr. 12, 2013

Related U.S. Application Data
(60) Provisional application No. 61/623,341, filed on Apr. 12, 2012.

(51) Int. Cl. B41J 3/407; G06F 17/30

(52) U.S. Cl. CPC B41J 3/4075; G06F 17/30286
USPC 235/375

(57) ABSTRACT

A system for labeling a patient specimen tube with identification information that includes a labeling device. The labeling device includes scanning and printing units electronically connected to a microcomputer. The scanning unit is configured to electronically read machine readable information provided on a patient identification article carried by the patient. The printing unit includes a print head. The microcomputer is programmed to receive information obtained by the scanning unit, interface with a database to correlate the received information with patient label information, format the patient label information, and prompt the printing unit to print the patient label information onto the specimen tube. In some embodiments, the database is maintained by a network server, with the labeling device electronically interfacing with the network server.

### CROSS REFERENCE TO RELATED APPLICATION

This Non-Provisional patent application claims the benefit of the filing date of U.S. Provisional Patent Application Ser. No. 61/623,341, filed Apr. 12, 2012, entitled “SPECIMEN TUBE LABELING SYSTEM,” which is herein incorporated by reference.

### BACKGROUND

The present disclosure relates to labeling patient specimen tubes with identification information. More particularly, it relates to systems for automated, consistent labeling of specimen tubes with patient and other ancillary identification information.

In multiple caregiver scenarios, a blood sample is taken from a patient, stored in a specimen tube, and then delivered to a laboratory, blood bank, or other resource (that may or not be at the caregiver's location) for subsequent procedures. It is imperative that the specimen tube be correctly labeled with patient identification information so that the analysis or other procedures performed by the lab or other resource are correlated with the correct patient.

One example illustrating the need for correct specimen tube labeling is pre-transfusion specimen collection. Prior to receiving a blood transfusion, a blood sample is taken from a patient and then sent to a laboratory blood bank. After analyzing the submitted specimen, the correct blood transfusion type can be selected and delivered back to the patient for transfusion. Unfortunately, errors in the pre-transfusion specimen collection process can occur, and are sometimes referred to as “wrong blood in tube” (WBIT). It is these WBIT errors that remain a large component of the total error in blood collection specimen identification, and their root cause has been largely unaddressed. WBITs are one of the most common errors in the transfusion process. For example, WBITs are estimated to occur in approximately 1 in 2,000 samples, and as many as 70% of WBIT errors occur at the patient bedside. The most severe result of WBIT is a patient receiving a transfusion of the wrong type of blood, known as incompatible blood component transfused (or IBCT). This can result in death. Other ramifications also exist outside the transfusion process including, but not limited to, the risk of delivering medical testing results or treatment based on those results to the wrong patient.

A common cause of WBIT is inaccurate labeling of the pre-transfusion, or other general phlebotomy, patient blood specimen. Currently, most specimen labeling activities are handled in an extremely manual process. Previous labeling techniques include retrieving a label from a chart at the patient's bedside at the time of specimen collection, and manually applying the label to the specimen tube. While viable, this approach requires strict patient identification protocol (e.g., the chart may be hung on the wrong bed); also, care is needed to ensure correct placement of the label on the specimen tube and to prevent accidental switching of two patients' specimens and labels. Similarly, a label can be retrieved from a batch printing system outside the patient's room (e.g., at a nursing station) and brought to the patient's bedside at the time of specimen collection. Once again, strict patient identification protocols must be implemented and followed, and care is needed to ensure correct placement of the label on the specimen tube. Similarly, a label can be retrieved from a specialized printing system provided at the laboratory, but again is subject to strict patient protocol and label application concerns as the label must be transported from a remote location to the patient's bedside. Alternatively, the patient information can be manually written onto the tube at the time of specimen collection. While not requiring special system components, the approach gives rise to legibility concerns, transcription errors, and correct placement on the specimen tube. Further, the same level of strict patient identification protocols as mentioned above must be followed.

More recently, systems have been made available that allow remote printing of labels at the patient's bedside upon scanning of patient identification information from a wristband worn by the patient. While viable, this approach requires costly hardware and still gives rise to problems in placing the label on the specimen tube. Also, in many instances, a connection to the caregiver's computer network is required to retrieve information to be printed on the specimen tube label. These network connections can at times be unreliable, leading to unplanned downtime in the specimen tube labeling process.

In light of the above, the need exists for an automated system for identifying and labeling a patient specimen tube to help reduce the occurrences of WBIT in the transfusion process and beyond.

### SUMMARY

Some aspects of the present disclosure relate to a system for labeling a patient specimen tube with identification information that includes a labeling device. The labeling device includes scanning and printing units electronically connected to a microcomputer. The scanning unit is configured to electronically read machine readable information provided on a patient identification article carried by the patient. The printing unit includes a print head. The microcomputer is programmed to receive information obtained by the scanning unit, interface with a database to correlate the received information with patient label information, format the patient label information, and prompt the printing unit to print the patient label information onto the specimen tube. In some embodiments, the database is maintained by a network server, with the labeling device electronically interfacing with the network server.

### BRIEF DESCRIPTION OF THE DRAWINGS

FIG. 1 is a block diagram of a system for labeling specimen tubes in accordance with principles of the present disclosure, including a specimen tube labeling device;

FIG. 2 is a block diagram of one embodiment of the labeling device of FIG. 1;

FIG. 3 is a simplified perspective view of a labeling device useful with the system of FIG. 1 and poised to receive a specimen tube;

FIG. 4 illustrates the labeling device of FIG. 3 loaded with a specimen tube and retrieving machine readable patient information from a patient wristband;

FIG. 5 illustrates the labeling device of FIG. 3 retrieving machine readable ancillary information from an ancillary article;

FIG. 6A illustrates the labeling device of FIG. 3 following printing of information on to the specimen tube label;

FIG. 6B is an enlarged view of a portion of the specimen tube of FIG. 6A, illustrating formatting of printed information;

FIG. 7 is a flow diagram of one method in accordance with principles of the present disclosure;

FIGS. 8A and 8B are enlarged perspective views of a printing unit useful with the labeling device of FIG. 2;

FIG. 9 is a cross-sectional view of the printing unit of FIGS. 8A and 8B, with portions removed;

FIGS. 10-10C illustrate an alternative specimen tube engagement component useful with the printing unit of FIG. 8A;

FIG. 11 is a simplified side view of another specimen tube engagement component useful with the printing unit of FIG. 8A;

FIG. 12 is a simplified side view of another specimen tube engagement component useful with the printing unit of FIG. 8A;

FIG. 13A is a simplified perspective view of a portion of a specimen tube useful with systems of the present disclosure;

FIG. 13B is a simplified perspective view of another specimen tube useful with systems of the present disclosure and a drive component useful with the printing unit of FIG. 2;

FIG. 13C is a simplified perspective view of another specimen tube useful with systems of the present disclosure;

FIG. 13D is a simplified side view of another specimen tube useful with systems of the present disclosure;

FIG. 13E is a simplified side view of another specimen tube useful with systems of the present disclosure and a drive component useful with the printing unit of FIG. 2;

FIG. 13F is a simplified side view of another specimen tube useful with systems of the present disclosure;

FIG. 14 is a simplified perspective view of another labeling device in accordance with principles of the present disclosure; and

FIG. 15 is a simplified side view of another specimen tube useful with systems of the present disclosure.

### DETAILED DESCRIPTION

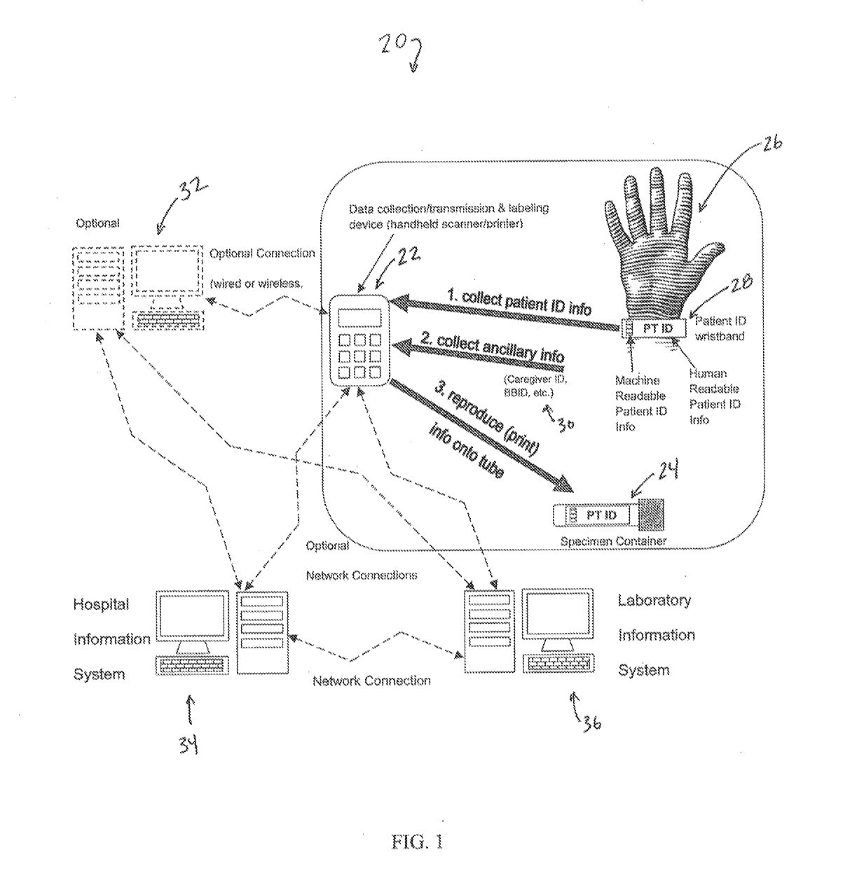

One embodiment of a direct specimen tube labeling system 20 in accordance with principles of the present disclosure is shown in FIG. 1. The system 20 includes a labeling device 22 configured to directly print identification information on to a specimen tube 24, with the so-printed identification information relating to a patient 26 from whom a specimen (e.g., blood sample) is or will be obtained and stored in the specimen tube 24. The printed identification information is derived by the labeling device 22 from patient identification information electronically collected or read from an article 28 associated with the patient 26. In some embodiments, the labeling device 22 is further configured to electronically collect ancillary information from an ancillary source 30 (referenced generally), and deriving additional information from the ancillary information for inclusion with the printed information (along with the printed patient identification information). In other embodiments, the labeling device 22 is optionally configured to electronically interface with one more additional sources of information, such as a remote work station 32, a hospital information system (HIS) server 34, and/or a laboratory information system (LIS) server 36. In this regard, the labeling device 22 can incorporate information received from one or more of the additional sources of information 32-36 into the information printed on to the specimen tube 24, or can signal data to one or more of the additional sources of information 32-36 to be saved in a corresponding database. In yet other embodiments, the labeling device 22 is configured to read machine readable patient information on the patient article 28 and use the so-obtained information to look up additional information to be included with the printed information on the specimen tube 24. Such additional information can include a work order number, test identification, or other subject matter that may not have been known or available at the time the article 28 was initially associated with the patient 26.

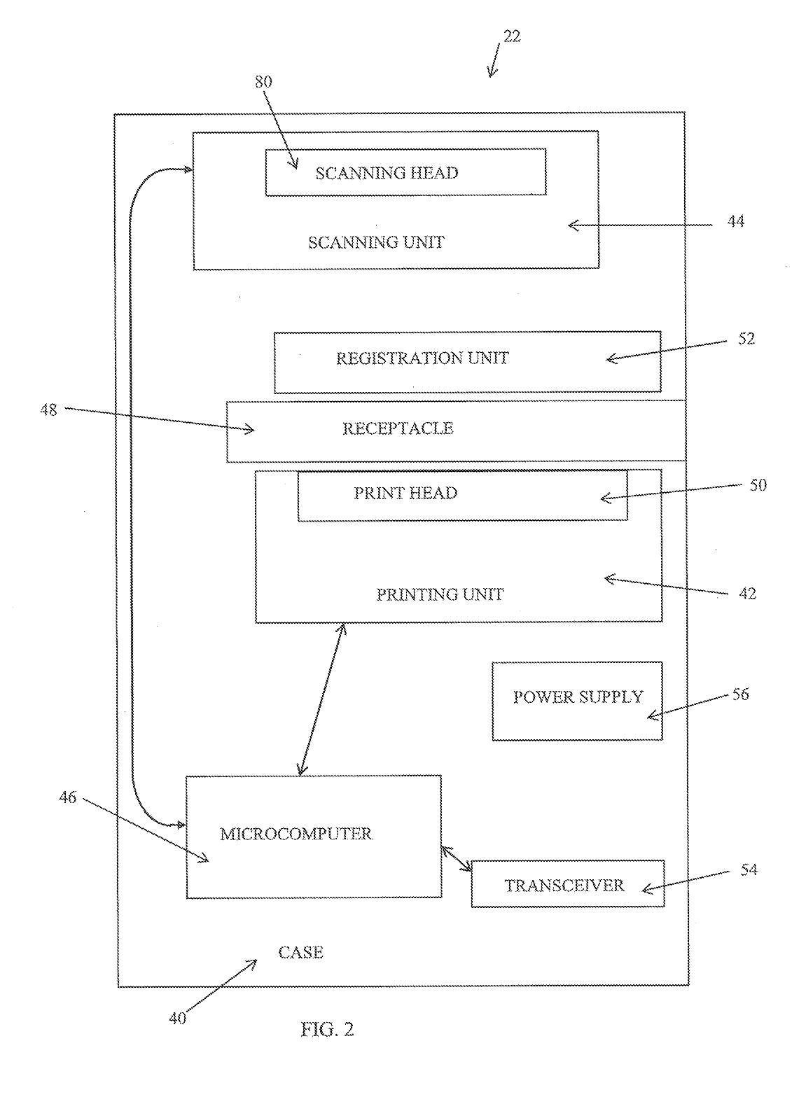

The labeling device 22 can assume various forms in accordance with principles of the present disclosure. With reference to FIG. 2, the labeling device 22 generally includes, in some embodiments, a case 40 maintaining a printing unit 42, a scanning unit 44 and a primary microcomputer 46. Details on the various components are provided below. In general terms, the case 40 can be sized and shaped for handling handled by one or both of an adult's hand, and forms a receptacle 48 configured to selectively receive the specimen tube 24 (FIG. 1). The printing unit 42 includes a print head 50 maintained proximate the receptacle for printing information on to the specimen tube 24 when loaded within the receptacle 48. The scanning unit 44 is formatted to electronically or optically read machine readable-type code or information (e.g., a bar code). The primary microcomputer 46 is electronically linked to the printing unit 42 and the scanning unit 44, and is programmed to format information received from the scanning device 44 and prompt operation of the printing unit 42 to print the so-formatted information. The labeling device 22 can optionally include additional components maintained by the case 40, such as a registration unit 52, a transceiver 54 and a power source 56 as described below. Also, a display and/or other user interface or input features can be included, some examples of which are described below.

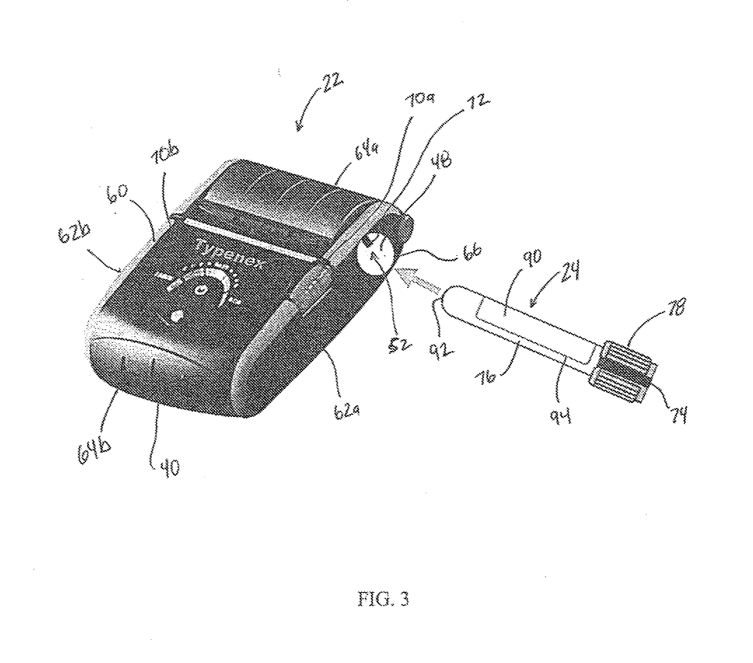

In some embodiments, the case 40 is generally sized and shaped for grasping by a single hand (or two hands) of an adult user, and can render the device 22 highly portable (e.g., the device 22 can be carried in a user's pocket in some constructions). In other embodiments, the case 40 can have a larger footprint that may or may not be portable (e.g., the labeling device 22 can be located on a table top) or the case 40 can be the housing of another device, thereby incorporating the functionality of the device 22 into another piece of equipment or instrumentation. The case 40 maintains the internal components of the device 22, and provides or forms various exterior features that facilitate interface with and/or operation of the components. One non-limiting example of the case 40 is depicted in FIG. 3. As shown, the case 40 generally defines opposing faces (a front face 60 being visible in FIG. 3), opposing sides 62a, 62b, and opposing ends 64a, 64b. With the one embodiment of FIG. 3, an opening 66 to the receptacle 48 (referenced generally) is formed in the first side 62a, with the case 40 having a width (i.e., dimension between the opposing sides 62a, 62b) commensurate with (e.g., slightly larger than) a length of a conventional specimen tube 24 (on the order of 50-100 mm) such that a majority, and in some embodiments an entirety, of the specimen tube 24 can be inserted into the receptacle 48 via the opening 66. In other embodiments, access to the receptacle 48 can be provided at other regions of the case 40 (e.g., the opening 66 can be formed at one of the ends 64a or 64b, and/or one of the opposing faces 60). In yet other embodiments, the case 40 can incorporate additional features or mechanisms that facilitate loading and removal of the specimen tube 24 relative to the receptacle 48. For example, the case 40 can carry a moveable (e.g., hinged or sliding) door that is opened/closed to provide access to the receptacle 48.

As generally reflected in FIG. 3, the case 40 carries or forms one or more user interface actuators, for example buttons 70a, 70b. The user interface actuators are adapted to facilitate user operation of the labeling device 22, and thus are electronically linked to the primary microcomputer 46 (FIG. 2), with the primary microcomputer 46 being programmed to perform a specific operation in response to a selected one of the user interface actuators. For example, actuation of the first button 70a can prompt the primary microcomputer 46 to operate the printing unit 42 (FIG. 2), and actuation of the second button 70b can prompt the primary microcomputer 46 to operate the scanning unit 44 (FIG. 2). The user interface actuators are not limited to the button format described above, and additional actuators can be provided. For example, the labeling device 22 can include a touch screen, a display screen, switches, roller ball, keyboard, mouse, trigger, etc.

With reference between FIGS. 2 and 3, and as indicated above, the receptacle 48 is formed by the case 40, and is sized and shaped to maintain a conventionally-sized specimen tube 24. The receptacle 48 can be defined in a variety of manners. For example, the case 40 can include internal framework (not shown) that slidably receives and maintains the specimen tube 24. Alternatively, and as described in greater detail below, the receptacle 48 can be more generally defined or generated in whole or in part by two or more rollers that combine to form a spacing within which the specimen tube 24 is received. Regardless, the receptacle 48 is arranged relative to the printing unit 42 so as to locate a loaded specimen tube 24 in close proximity to the print head 50.

The optional registration unit 52, where provided, ensures that the specimen tube 24 is loaded in a desired orientation relative to the print head 50, and thus can be configured in tandem with features of the specimen tube 24. For example, and as implicated by the non-limiting example of FIG. 3, the registration unit 52 can include a tab 72 formed or carried by the case 40 at the opening 66 to the receptacle 48. The tab 72 is sized to be slidably received within a slot 74 formed by the specimen tube 24. As a point of reference, specimen tubes 24 conventionally include a tubular body 76 forming an open end that is closed by a stopper or cap 78. The stopper 78 carries a sealable membrane for sealing the contents (e.g., blood) of the tubular body 76. With this in mind, the slot 74 can be formed in or along the cap 78 (as shown), the tubular body 76, or both. Regardless, the tab 72 prevents the specimen tube 24 from being fully inserted into the receptacle 48 unless the slot 74 is aligned with the tab 72 (thus orienting the specimen tube 24, and any pre-applied label carried thereby, at a known orientation relative to the print head 50).

The registration unit 52 can assume a variety of other forms that may or may not utilize features incorporated into the specimen tube 24. For example, the registration unit 52 can be optically based (e.g., optically “recognizing” a line or logo provided on the specimen tube label prior to printing). In related embodiments, the optically-based registration unit 52 can be operated to sense or detect the presence of printed information on the specimen tube 24 (prior to a printing operation by the labeling device 22) and thus prevent “re-labeling” of a specimen tube that already has printed information. With these same embodiments, a user override feature can be provided by the device 22, allowing a user to render pre-existing printed information illegible by printing over the existing information with an arbitrary pattern or set of characters. This latter operation can be useful when, for example, the patient becomes unavailable for specimen collection after the time of tube labeling due to another medical complication. Further, the registration unit 52 can include one or more additional mechanisms that automatically orient the specimen tube 24 relative to the print head 50 regardless of an arrangement of the specimen tube 24 upon initial insertion into the receptacle 48 by a user. In yet other embodiments, the registration device 52 can be omitted. Where omitted, if a particular orientation of the specimen tube 24 relative to the labeling device 22 is necessary or desired, a user can align indicia on the specimen tube 24 with indicia on the case 40 for example.

With specific reference to FIG. 2, the printing unit 42 can assume a variety of forms, and is sized to be completely retained within the case 40. In some embodiments, the printing unit 42 is a direct thermal printer. Other printing device formats (e.g., thermal transfer, inkjet, non-contact laser, etc.) can alternatively be employed. Direct thermal printers are well known, such as those available from Fujitsu of Tokyo, Japan, with the print head 50 configured as a thermal head, maintaining an array of heating elements that are selectively energized. When energized, the heating element(s) deliver heat to corresponding regions of a thermosensitive paper or label that in turn changes color where heated. As described below, the thermosensitive paper or label (identified as the label 90 in FIG. 3) is pre-applied to the specimen tube 24 in some embodiments (i.e., prior to insertion of the specimen tube 24 into the receptacle 48). In other embodiments, the labeling device 22 carries a supply of the thermosensitive paper or labels, and is configured to apply the label onto the specimen tube 24 once inserted into the receptacle 48 (e.g., before or after printing).

The printing unit 42 includes additional components (not shown) conventionally required for operation of the printing unit 42 in printing information on to the specimen tube 24 (it being understood that “printing information” is inclusive of the direct thermal printing techniques described above in which the print head 50 applies heat to specially constructed thermosensitive paper or label carried by the specimen tube 24). For example, the printing unit 42 can include one or more mechanisms that selectively bring the print head 50 into contact with a loaded specimen tube 24. Further, the printing unit 42 can include a microprocessor or similar print engine embedded or programmed with firmware that manages operation of the print head 50. The firmware can be electronically linked to the primary microcomputer 46 (such that the primary microprocessor 46 prompts operation of the printing unit 42 print engine in a desired fashion), or the primary microcomputer 46 can be loaded/programmed with the firmware.

The scanning unit 44 can assume a variety of forms, and with the embodiment shown in FIG. 3, is sized to be completely retained within the case 40. Alternatively, the scanning unit 44 can be a component apart from the case 40 that is connected to the microcomputer 46 by wired or wireless connection during use of the labeling device 22. The scanning unit 44 is generally configured to read or scan machine readable indicia, such as barcodes, RFID tags, magnetic stripes, etc., and thus will include hardware conventionally employed for the desired end application. For example, where the scanning unit 44 is adapted to read barcode-type information, conventional barcode scanner components such as a light source, a lens, and a light sensor configured to translate optical impulses into electrical impulses are included. Further, the scanning unit 44 will include decoder circuitry programmed to analyze the barcode's image data as provided by the sensor and signal the so-analyzed barcode content from an output port of the scanning unit 44. Other components normally included with the particular type of scanning unit 44 employed (e.g., laser scanner, CCD reader, camera-based readers, etc.) are also included. Regardless, a scanning head 80 provided with the scanning unit 44 is carried adjacent an end or side of the case 40 (e.g., the first end 64a in FIG. 3), and is thus available for obtaining barcode information (or other machine readable indicia to be scanned). While the decoder circuitry and corresponding algorithms are conventionally provided with the scanning unit 44 (with the decoded machine readable information being signaled to the primary microcomputer 46), in other embodiments the primary microcomputer 46 is programmed with the necessary decoding algorithms. In yet other embodiments, the device 22 can include two or more different types of scanning units 44 (e.g., a first scanning unit adapted to scan barcodes and a second scanning unit adapted to read information from an RFID tag). While the scanning unit 44 has been described as being adapted to scan machine readable indicia, in other embodiments, patient biometric data scanning can alternatively be performed. For example, the scanning unit 44 (or an additional scanning device provided with the labeling device 22) can be adapted to scan a patient's finger print, retina, etc., with the so-obtained information being compared to a database correlating the biometric data with patient-specific background information as described below.

The primary microcomputer 46 is programmed or adapted to control overall operation of the device 22, and includes a processing unit (e.g., a microprocessor as known in the art such as a single or dual microprocessor or other multiprocessor architecture) that may be linked to additional components such as memory (random access memory, flash memory, read only memory, etc.). The processing unit is programmed with one or more algorithms adapted to control operation of the device 22 in a desired fashion, and can be in the form of software and/or firmware, for example. One particular algorithm or system architecture provided with the primary microcomputer 46 is formatting of information to be printed on the specimen tube 24 as described below. In general terms, the formatting logistics includes parsing information received from one or more sources (e.g., patient information received from the scanning unit 44) and arranging the so-parsed information into a pre-determined format conducive to printing on to the specimen tube 24. The primary microcomputer 46 software and/or firmware can be updated at any time to incorporate new functionality or to enhance or debug current functionality. To accomplish such updates, the device 22 can be configured for connection by a user to a local or remote file server (wired or wireless), connection to a local computer (e.g., via USB or other protocol), or insertion of a flash memory card into a compatible port (not shown) provided by the device 22.

The optional transceiver 54 can be of a type known in the art and facilitates either wired or wireless communication between the device 22 and a terminal (as described below). With wired communication constructions, the transceiver 54 can include an Ethernet network interface adapter or other such components known to those of skill in the art. With wireless embodiments, the transceiver 54 can provide NFC, Bluetooth, RF, IR, Wi-Fi and/or any other suitable wireless techniques or mechanisms for interaction with the terminal component. The transceiver 54 can include additional components for converting received information into a format compatible with the primary microcomputer 46 (and vice-versa for information to be transmitted by the transceiver 54), or the converting circuitry and algorithms can be provided with the primary microcomputer 46. In addition to the optional wireless transceiver 54 and corresponding circuitry, the device 22 is optionally configured for wired communication with the terminal device (e.g., the case 40 can carry an input port (e.g., USB or serial port) electronically connected to the primary microcomputer 46).

The power supply 56 can be a battery, such as a rechargeable lithium-based battery, carried by the case 40 and adapted to power at least the printing device 42, the scanning device 44 and the primary microcomputer 46. In other embodiments, one or more of the components 42-46 can have its own designated power supply. In related embodiments, the case 40 can be configured to facilitate re-charging of the power supply 56 when connected to a re-charger. Alternatively, the device 22 does not include an internal power source and is configured for connection to a conventional, external source of AC or DC power.

The labeling device 22 can include a variety of other features not directly shown in the drawings, but useful in performing one or more of the operations described below. In general terms, use of the device 22 in labeling the specimen tube 24 with patient information begins with the arrangement of FIG. 3. Immediately before a patient specimen is to be drawn and dispensed into the specimen tube 24 (or, in some instances, immediately after drawing the sample), the specimen tube 24 is loaded into the receptacle 48. With the one embodiment shown, the specimen tube 24 is optionally provided to the user with a pre-applied, un-printed or blank label 90. The label 90 can assume various forms, and with embodiments in which the printing unit 42 (FIG. 2) is a direct thermal printer, the blank label 90 can be a thermosensitive paper or film, or a paper or film coated with a thermosensitive or thermochromic material. By pre-applying, the blank label 90 can be desirably located along the tubular body 76 such that the blank label 90 does not cover or extend over the stopper 78, and does not project beyond a closed end 92 of the tubular body 76. Further, the blank label 90 can be sized to desirably cover less than an entire circumference of the tubular body 76. For example, the blank label 90 defines opposing edges 94 (one of which is visible in FIG. 3). As applied to the tubular body 76, the opposing edges 94 are spaced from one another, allowing a user to visually confirm contents of the specimen tube 24. With this construction, then, where the specimen tube 24 provides a feature for interfacing with the optional registration device 52 (e.g., the slot 74), the pre-applied blank label 90 can be positioned such that the edges 94 are at a known location relative to the slot 74 (or other registration feature) thereby ensuring that the print head 50 (FIG. 2) will interact with the blank label 90 at an appropriate location during a printing operation. In other embodiments, the blank label 90 can be applied to the specimen tube 24 by the user. In yet other embodiments, the label 90 material can be internally carried by the device 22, with the device 22 operating to apply the label onto the specimen tube 24 either before or after printing.

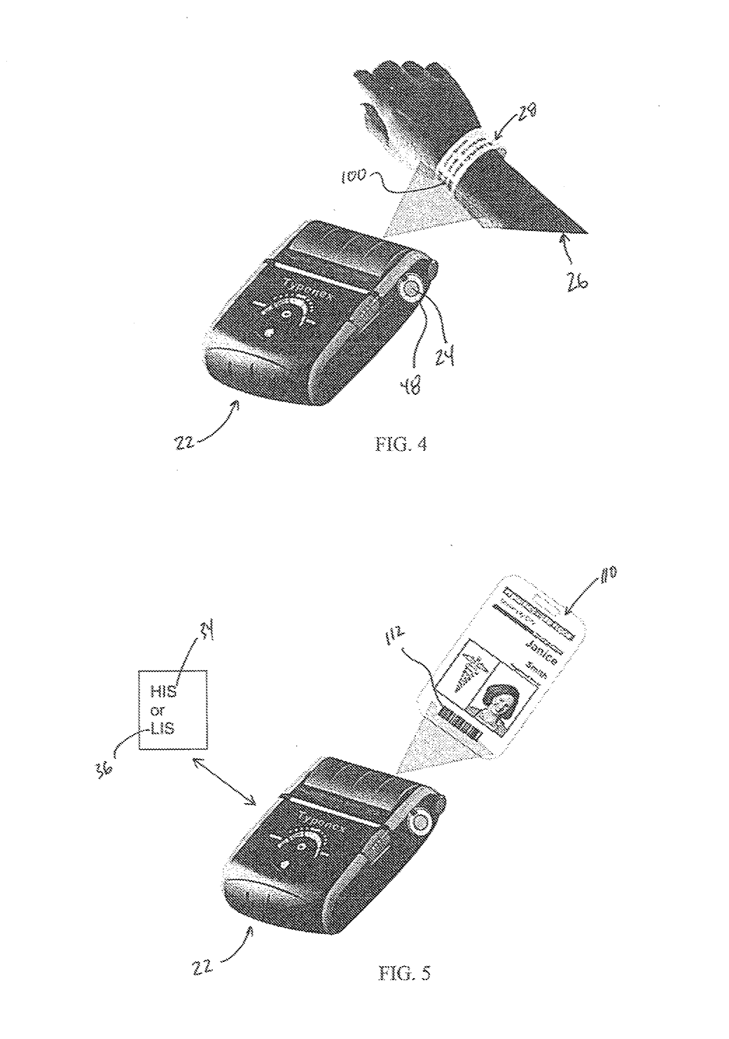

Regardless of how the blank label 90 is applied, once the specimen tube 24 has been loaded into the receptacle 48, the labeling device 22 is operated to electronically read machine readable patient information from the article 28 carried by the patient 26. As a point of reference, the article 28 shown in FIG. 4 is a wristband applied to the patient 26. With conventional caregiver protocols, during admission to the caregiver institution (e.g., hospital), various background information relating to the patient 26 is created and stored in an electronic caregiver database (known, for example, as an Admission, Discharge and Transfer (or ADT) database), such as the patient's full name, date of birth, date of admission, caregiver, etc. Further, a unique identification code may be assigned to the patient 26 permanently or for a particular visit, and the patient-specific background information is correlated with the unique identification code in the caregiver's electronic database. Some or all of this background information, along with the unique identification code, is displayed on the wristband 28 that in turn is applied to an appendage of the patient 26 in a tamper-evident fashion. The identification code can be displayed on the wristband 28 in human readable, alphanumeric form. In addition, wristband 28 includes machine readable indicia 100 (referenced generally in FIG. 4), such as a barcode, an RFID tag, a magnetic stripe, etc. The machine readable indicia 100 is formatted to represent, in machine readable form, the patient background information (in whole or in part), the unique identification code, and optionally other information as desired by the caregiver.

In some instances, the wristband 28 (or similar article to be applied to the patient) is initially provided to the caregiver (i.e., prior to admitting a particular patient) with the unique identification code already printed thereon. The patient background information (as obtained during the admission process) is then printed onto the wristband 28 or printed onto a label that is applied to the wristband 28. The machine readable indicia 100 can also be included with the wristband 28 as provided to the caregiver (e.g., the wristband 28 can have a pre-printed barcode, carry an RFID tag, etc.). Under these circumstances, as part of the admissions process, the caregiver institution's computer system will format, program or otherwise associate the machine readable indicia 100 with the obtained patient background information and identification code. Alternatively, the machine readable indicia 100 can be applied to the wristband 28 as part of the admission process for a particular patient (e.g., during the admission process, a barcode embodying the patent background information and the identification code is printed onto the wristband or is printed onto a label that is applied to the wristband 28). Regardless, in final form, the machine readable indicia 100 is formatted to represent the desired patient background information and the identification code in a machine readable format.

With the above in mind, the device 22 is operated to read or scan the machine readable indicia 100, retrieving the information embodied by the machine readable indicia 100. For example, the user “aims” the scanning head 80 at the machine readable indicia 100, and then presses a corresponding user interface actuator (e.g., the button 70b). The primary microcomputer 46 (FIG. 2) operates to prompt operation of the scanning unit 44 (FIG. 2) to scan/read the machine readable indicia 100. The so-obtained information is then signaled to the microcomputer 46 and saved in memory as “patient information”. The patient information can be saved on a temporary basis for privacy reasons, on a longer term basis for later record keeping and/or synchronizing with the caregiver's database. Regardless, the patient information can be saved in block or mass form, or can be parsed and saved in pre-determined, subject matter specific sub-files for reasons made clear below. For example, the machine readable indicia 100 can be formatted by the caregiver institution to organize certain information in a pre-determined order (e.g., patient name, followed by date of birth, followed by physician name, etc.). The microcomputer 46 is programmed to recognize this pre-determined ordering, parsing out and saving the discrete strings of information in separate sub-files (e.g., the patient's name is stored in a first sub-file, date of birth in a second sub-file, etc.). Alternatively, the parsing of particular subject matter from the received patient information can be performed by the microcomputer 46 as part of a print operation.

As shown in FIG. 5, the labeling device 22 is optionally then operated to obtain additional, ancillary information from an ancillary article 110. The ancillary article 110 can assume a variety of forms, and in some embodiments is an identification badge carried by the caregiver. Regardless, the ancillary article 110 carries or forms machine readable indicia 112 (e.g., barcode, magnetic stripe, RFID tag, etc.) representing (in machine readable format) information relating to the caregiver, alternative unique patient identification information, the procedure to be performed, etc. (“ancillary information”). Where provided, the scanning unit 44 (FIG. 2) is prompted by the microcomputer 46 (FIG. 2) to read the ancillary machine readable indicia 112 as described above, and signal the retrieved information to the microcomputer 46. The microcomputer 46 stores the ancillary information as previously described (in either block form, or data of interest is parsed and saved in designated subject matter sub-files).

FIG. 5 further reflects that the device 22 is optionally operated to electronically communicate with one or more terminals, such as the HIS 34 and/or the LIS 36. For example, the microcomputer 46 (FIG. 2) can operate through the transceiver 54 (FIG. 2) to obtain additional ancillary information of interest (e.g., current date, procedure specific information, etc.) In addition or alternatively, communications with the HIS 34 and/or the LIS 36 can confirm whether obtained patient information or ancillary information is correct and/or has been updated, how information should be formatted or printed, etc.

Optionally, additional information can be supplied to the microcomputer 46 by a caregiver/user. For example, the device 22 can include a touchpad or keyboard that permits the caregiver to manually enter patient information of interest. In yet other, less preferred embodiments, all necessary patient information is manually entered into the device 22, and the machine readable indicia 100 need not necessarily be scanned.

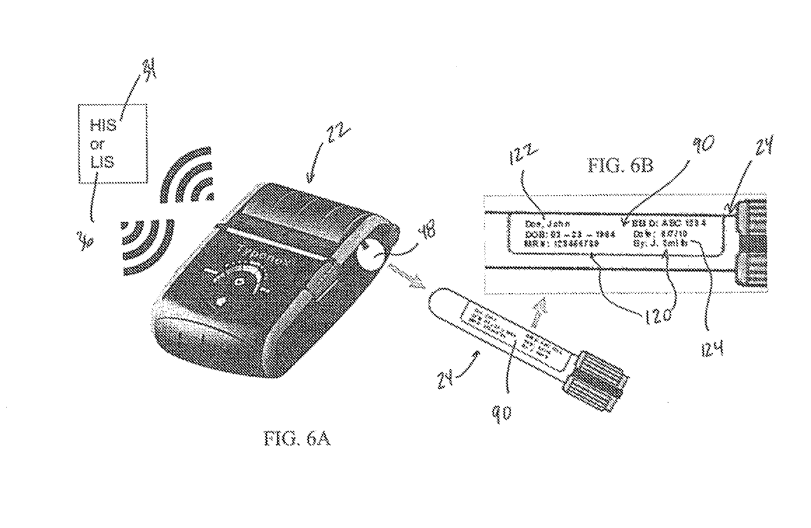

With the patient information and ancillary information in hand, the microcomputer 46 prompts the printing unit 42 to print label information 120 on to the label 90 as shown in FIG. 6A, for example in response to user actuation of a corresponding user interface (e.g., the button 70a). The labeling information 120 is derived by the microcomputer 46 from the retrieved patient and ancillary information, and is formatted in a predetermined manner as described below. One acceptable formatting of the labeling information 120, as dictated by the microcomputer 46, is provided in FIG. 6B, and includes patient information 122 (e.g., patient name, date of birth, and identification code) and ancillary information 124 (e.g., current date and caregiver). The labeling information 120 is depicted in FIG. 6B as being entirely alphanumeric, or human readable, in form. Alternatively, the labeling information 120 can be, or can include, machine readable formatting (e.g., printed barcode, programmed RFID tag, etc.). Optionally, the device 22 can be operated to communicate with one or more terminals, such as the HIS 34 and/or the LIS 36, for example signaling information that confirms the specimen tube 24 has been collected. Once printing is complete, the specimen tube 24 is removed from the receptacle 48 and can be further processed (e.g., delivered to a laboratory).

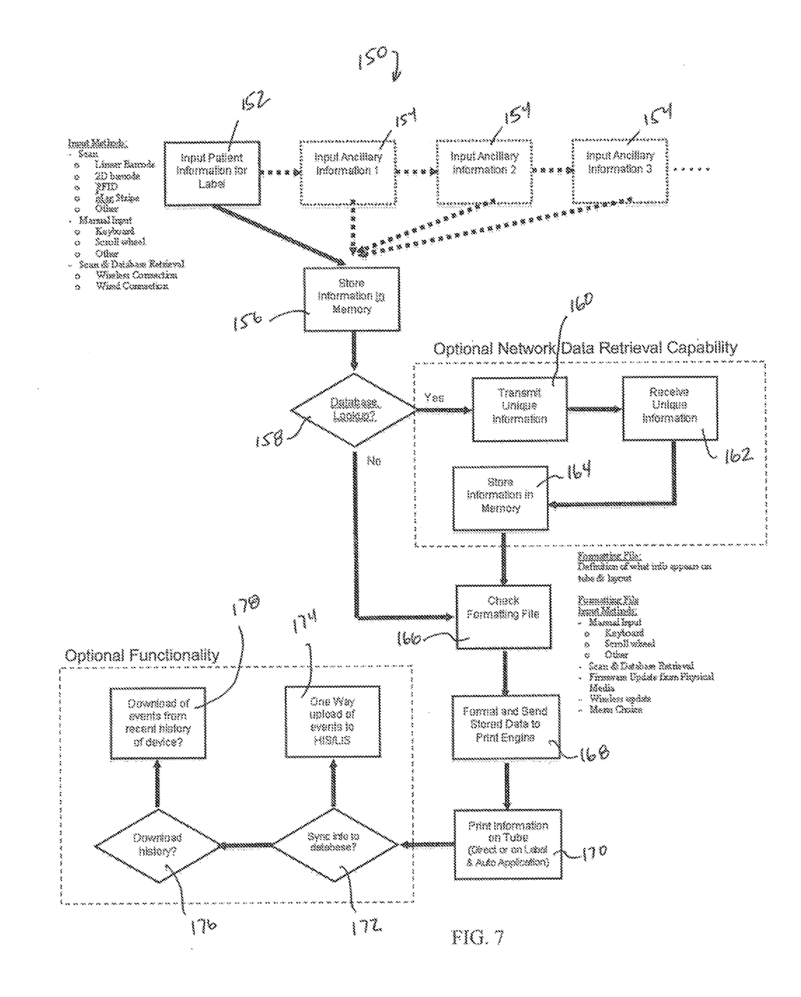

Other features associated with use of the labeling device 22 are set forth in the process flow diagram 150 of FIG. 7. At step 152, patient information is retrieved. Optionally, at step 154, ancillary information is retrieved. As indicated, the patient information and the ancillary information can be obtained by operating the scanning unit 44 (FIG. 2) to read the machine readable indicia (e.g. barcode, RFID tag, magnetic stripe, etc.), manually inputted, etc. At step 156, the retrieved information is stored in memory. At step 158, the some or all of the stored information is optionally compared with a separate database. For example, at step 160, some or all of the stored information is communicated to a separate terminal (e.g., the HIS 34 (FIG. 1)). The separate terminal matches the received information with a corresponding database maintained or accessible by the terminal, and retrieves additional information from the database and delivers the so-retrieved information back to the device 22 at step 162. This additional information is stored in memory at step 164.

Regardless of whether additional information is retrieved at steps 160-164, at step 166, the microcomputer 46 (FIG. 2) determines a desired formatting for the labeling information 120 (FIG. 6B). The formatting can include type of information to be printed, location of information along the label 90 (FIG. 6B), font size, etc. The formatting can be dictated by a formatting file or algorithm programmed to, or referenced by, the microcomputer 46. The formatting file provides a definition of what information will be printed on to the label 90 and the layout of the information. The formatting file can be supplied to the microcomputer 46 in various manners, such as directly by a user, via a separate computer, or at the factory.

The microcomputer 46 (FIG. 2) then compares the stored information with the formatting file, formats the stored information in accordance with the definitions provided by the formatting file, and delivers the formatted information to the printing device 42 (FIG. 2) at step 168. Where the retrieved patient and ancillary information has been saved in parsed form, the microcomputer 46 can retrieve information from the appropriate sub-folders in the order designated by the formatting file. Alternatively, the microcomputer 46 can refer to the formatting file for the necessary ordering of information, and then parse out the requisite data from the stored information. Regardless, the formatting file serves as a template and can provide the microcomputer 46 with additional “instructions” for information to be displayed (e.g., the letters “DOB” are to appear prior to the patient's date of birth, with the date of birth data being parsed from the stored patient information).

At step 170, the printing unit 42 is prompted to print the formatted information on to the label 90 (FIG. 6B) as described above. Optionally, the device 22 can further be operated to communicate with one or more terminals. For example, at step 172, a determination can be made as to whether the database maintained by a separate terminal (e.g., HIS 34 and/or LIS 36) should be synchronized or updated with information indicative that the specimen tube 24 collection has been completed. If so, event information is uploaded to the terminal via the transceiver 54 (FIG. 2) at step 174. In addition (or alternatively), a decision can be made at step 176 as to whether a history of usage of the device 22 should be downloaded to another device/terminal; if so, the download is effectuated at step 178.

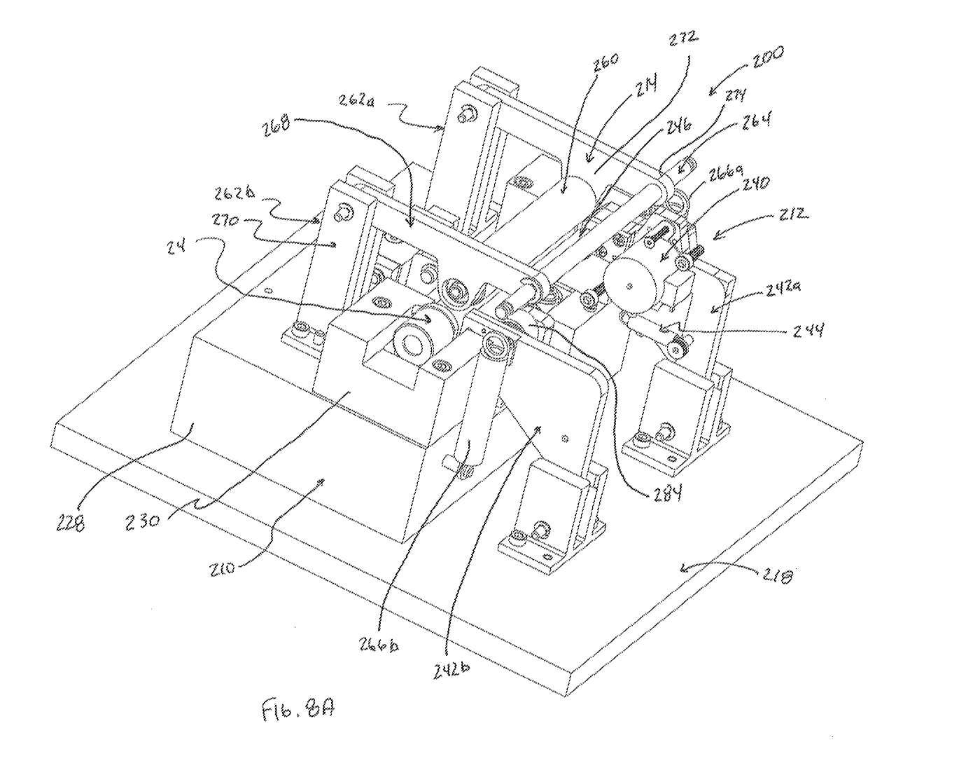

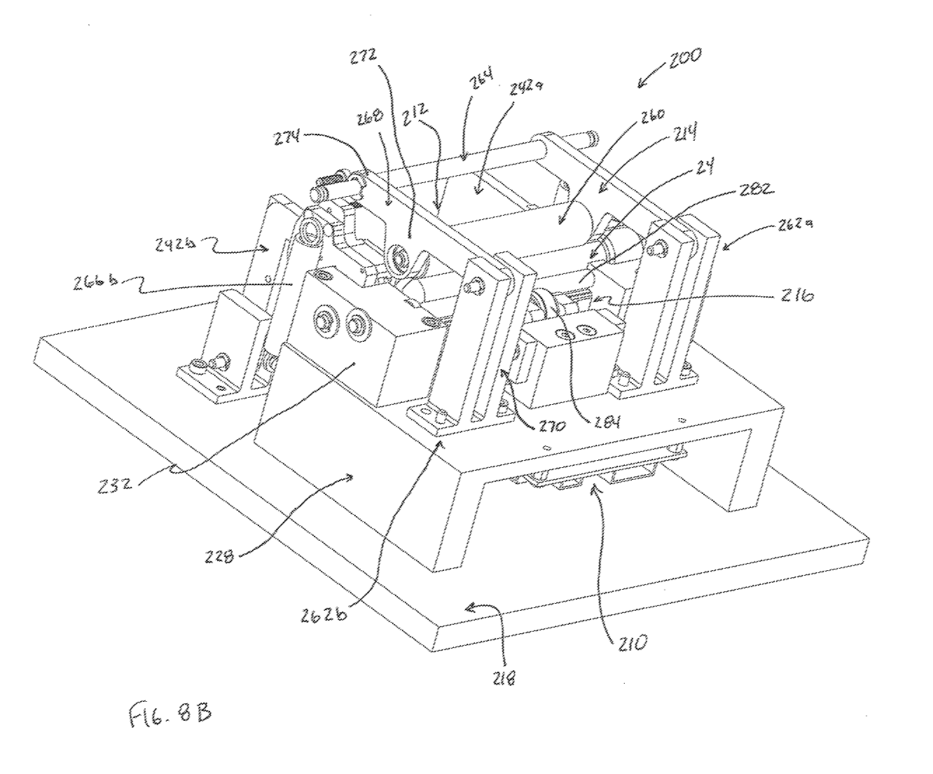

The methods of operating the labeling device 22 in retrieving and formatting information for printing on to the specimen tube 24 can vary in many respects from the descriptions provided above. Similarly, the mechanisms carried by the device 22 for applying printed information on to the specimen tube 24 can also assume a variety of forms in accordance with above descriptions. In some embodiments, the printing unit 42 utilized with the device 22 is a direct thermal printer having components in addition to the print head 50 for supporting the specimen tube 24 during a printing operation. One non-limiting example of a printing unit 200 incorporating a direct thermal printer and useful with the labeling device 22 is shown in greater detail in FIGS. 8A and 8B. The printing unit 200 is configured for printing information onto a label carried by a specimen tube 24, and is configured to be contained within the hand-held case 40 (FIG. 3) described above. With this in mind, and as generally referenced in FIGS. 8A and 8B, the printing unit 200 includes a printer assembly 210, a drive assembly 212, a pressure assembly 214, and a support assembly 216. Details on the various components are provided below. In general terms, however, the support assembly 216 supports and maintains the specimen tube 24 relative to a print head component (hidden in FIGS. 8A and 8B) of the printer assembly 210. The pressure assembly 214 imparts a force onto the specimen tube 24 opposite the print head, with the support assembly 216 supporting the specimen tube 24 against the so-imparted load at opposite sides of the print head. As a result, the specimen tube 24 is caused to flatten immediately adjacent the print head to facilitate direct linear contact between the print head and the specimen tube/label 24. Finally, the drive assembly 212 operates to selectively rotate the specimen tube 24 relative to the print head during the printing operation. As a point of reference, the assemblies 210-216 are shown in FIGS. 8A and 8B as being collectively supported by a base block 218 for ease of illustration. The base block 218 can be a wall of the case 40 (FIG. 3) or can be mounted within the case 40. All components of the printing unit 200 can assume alternative forms differing from the descriptions below while maintaining the same functionality to, for example, reduce the size of the case 40 and improve ease of handling.

Components of the print assembly 210 are shown in FIG. 9, and include a print head 220, circuitry 222, a mounting plate 224, a biasing mechanism 226, a printer support block 228, and opposing, first and second end blocks 230 (FIG. 8A), 232 (FIG. 8B). The print head 220 is a direct thermal print head as known in the art, with heating elements (not shown) carried thereby being selectively energized by the circuitry 222. The circuitry 222 thus serves as the print engine and can assume any construction normally employed for direct thermal printing. Alternatively, the print engine circuitry can be incorporated into the microcomputer 46 (FIG. 2). The mounting plate 224 is coupled to the print head 220, and locates the print head 220 relative to the specimen tube 24. In this regard, the biasing mechanism 226 is disposed between the mounting plate 224 and the printer support block 228, with the printer support block 228 being attached to the base block 218. With this construction, the biasing mechanism 226 biases the mounting plate 224, and thus the print head 220, toward the specimen tube 24 ensuring contact between the print head 220 and the specimen tube 24 (and the label carried thereon) with a deliberate yet adjustable level of force. Further, the biasing mechanism 226 allows the mounting plate 224/print head 220 to move toward the base block 218, for example to accommodate a specimen tube that is larger (in diameter) than the specimen tube 24 shown. Finally, and as shown in FIGS. 8A and 8B, the first end block 230 is sized and shaped to support an end of the specimen tube 24 upon insertion into the printing device 200, whereas the second end block 232 is configured to provide a positive stop to insertion of the specimen tube 24. While the second end block 232 is shown as being a stationary body (relative to base block 218), in other embodiments the second end block 232 can be slidable and biased to a home position. With insertion of the specimen tube 24, the second end block 232 will slide and can thus provide an indication to the microcomputer 46 as to the size (length) of the specimen tube 24 being processed.

With cross-reference between FIGS. 8A-9, the drive assembly 212 includes a drive motor 240, support arms 242a, 242b, springs 244, and a drive roller 246. The drive motor 240 operates to rotate the drive roller 246, for example via an intermediate gear train (not shown). The drive roller 246 is rotatably connected to the support arms 242a, 242b, and the support arms 242a, 242b are pivotably attached to the base block 218. Each of the springs 244 applies a biasing force onto the corresponding support arm 242a, 242b, causing the support arms 242a, 242b to pivot relative to the base block 218 in a manner that biases the drive roller 246 into engagement with the specimen tube 24. For example, the springs 244 can be helical springs attached at one end to the printer support block 228 and at an opposite end to the corresponding support arm 242a, 242b. Finally, the drive motor 240 can be mounted to the first support arm 242a, and is electronically connected to a controller (for example the primary microcomputer 46 (FIG. 2)) that otherwise operates to control operation of the drive motor 240.

The pressure assembly 214 includes a pressure roller 260, first and second support mechanisms 262a, 262b, a shaft 264 and springs 266a, 266b. The pressure roller 260 is rotatably coupled to and supported by the support mechanisms 262a, 262b. The support mechanisms 262a, 262b can be identical, each including a link arm 268 and a foot 270. The foot 270 is fixed relative to the base block 218, for example by being attached to the printer support block 228 (that in turn is mounted to the base block 218). The link arm 268 is pivotably coupled to the foot 270. The pressure roller 260 is rotatably coupled to an intermediate segment 272 of the link arm 268, whereas the shaft 264 is attached to a leading segment 274. In this regard, the shaft 264 extends between and outwardly beyond the link arm 268 of each of the support mechanisms 262a, 262b, thus providing surface area for attachment to the corresponding spring 266a, 266b. As a point of reference, the springs 266a, 266b are shown as being uncoupled from the shaft 264 in FIGS. 8A and 8B for ease of illustration. Upon final assembly, each of the springs 266a, 266b extends between the shaft 264 and the printer support block 228 (it being recalled the printer support block 228 is mounted to the base block 218). With this construction, the springs 266a, 266b bias the shaft 264 toward the base block 218; this biasing force is transferred onto the link arms 268, causing the link arms 268 to pivot relative to the corresponding foot 270 and biasing the pressure roller 260 into contact with the specimen tube 24.

The support assembly 216 includes first and second roller mechanisms 280a, 280b. The roller mechanisms 280a, 280b can be generally identical in construction, each including an idle roller 282, a back-up roller 284, and a framework 286. The framework 286 rotatably supports the idle roller 282 and the back-up roller 284 relative to the base block 218 (e.g., via the printer support block 228), with the back-up roller 284 bearing against the corresponding idle roller 282. The idle roller 282 of the first roller mechanism 280a is located immediately adjacent a first side of the print head 220, and the idle roller 282 of the second roller mechanism 280b is located immediately adjacent an opposing, second side. With this construction, the idle rollers 282 can rotate with rotation of the specimen tube 24, but robustly support the specimen tube 24 immediately adjacent the print head 220. In related embodiments, the idle rollers 282 are movably mounted so as to allow for support specimen tubes of varying diameters. In other constructions, the idle rollers 282 can be replaced with frictional support plates or similar components.

During use, the specimen tube 24 is loaded into the printing unit 200, inserted along the idle rollers 282. The specimen tube body 76 is supported by the idle rollers 282, whereas the cap 78 is received by the first end block 230. The second end block 232 provides a positive stop to over-insertion of the specimen tube 24. The drive roller 246 is biased into frictional contact with the specimen tube 24 along the length of the specimen tube body 76. The pressure roller 260 is also biased against the specimen tube 24 along the length of the specimen tube body 76 from a location opposite the print head 220. In this regard, the pressure roller 260 effectively applies a “flattening” force onto the specimen tube 24, causing the specimen tube 24 to come into full contact with the print head 220. Thus, any deviations in an inherent “straightness” of the specimen tube 24 along the print head 220 tangency line are obviated. The idle rollers 282 reduce the frictional forces of the specimen tube 24 against the print head 220, supporting the high load imparted by the pressure roller 260. Once the specimen tube 24 has been located between the pressure roller 260 and the idle rollers 282, the print head 220 is biased into contact with the specimen tube 24/label surface via a separate biasing force to provide the requisite print head-to-media contact pressure for correct printing. During a printing operation, the drive roller 246 is operated to selectively rotate the specimen tube 24 relative to the print head 220.

The high flattening forces increase friction in the printing unit 200, and thus may require an increased torque to rotate the tube. To meet these requirements, the drive roller 246 can be constructed of a low durometer rubber to increase grip against the specimen tube surface. Alternatively, the pressure roller 260 can be operated as a drive roller (either in combination with the drive roller 246, or as a standalone drive roller (i.e., the drive roller 246 can be eliminated)). Under these circumstances, the pressure roller 260 can be include a high friction coating or sandblast treatment. Additionally, the printing unit 200 can include a cam mechanism or a separate motor and jack screw mechanism to raise the pressure roller 260 at the beginning/conclusion of the print cycle to facilitate loading/unloading of the specimen tube 24.

As an alternative to implementation of the pressure assembly 214 to address the specimen tube straightness concerns mentioned above, in other embodiments the specimen tube body 76 is manufactured (e.g., molded) to provide necessary straightness. For example, the specimen tube body 76 can be manufactured to exhibit a straightness of +/−0.05 mm along an edge tangency within a boundary of 3 mm from the open end and 3 mm from the bottom tangent point.

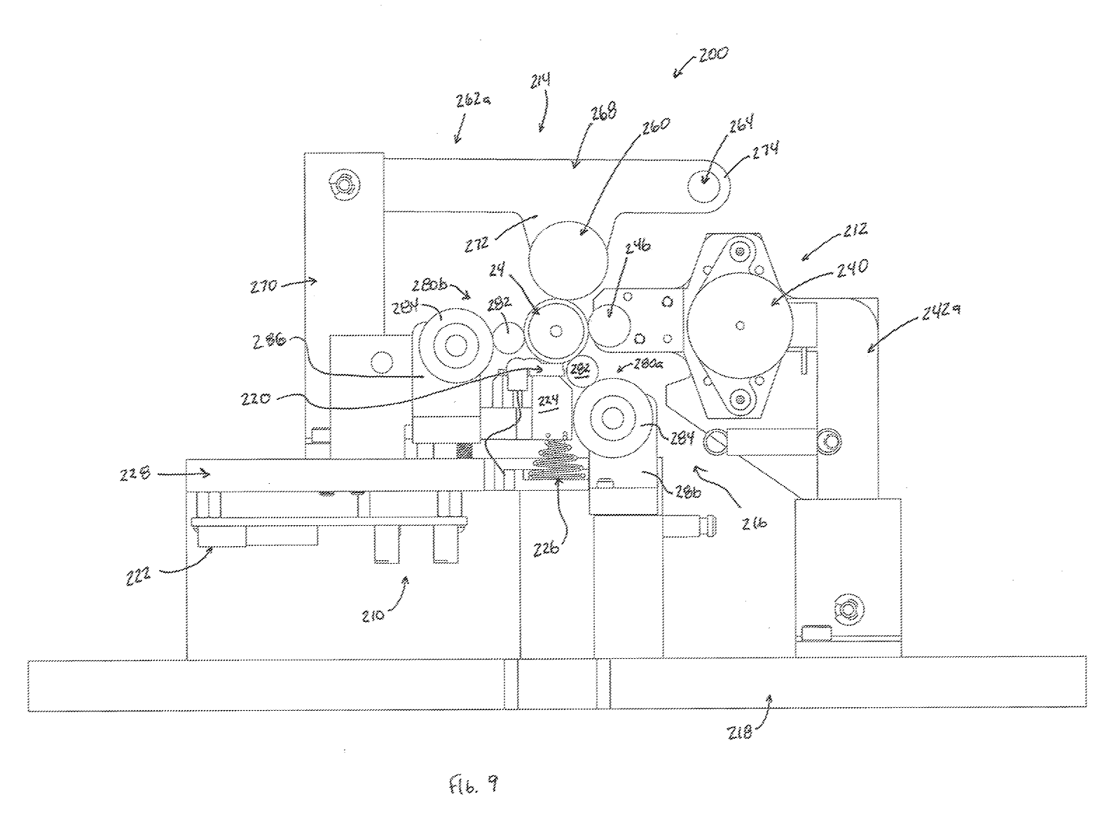

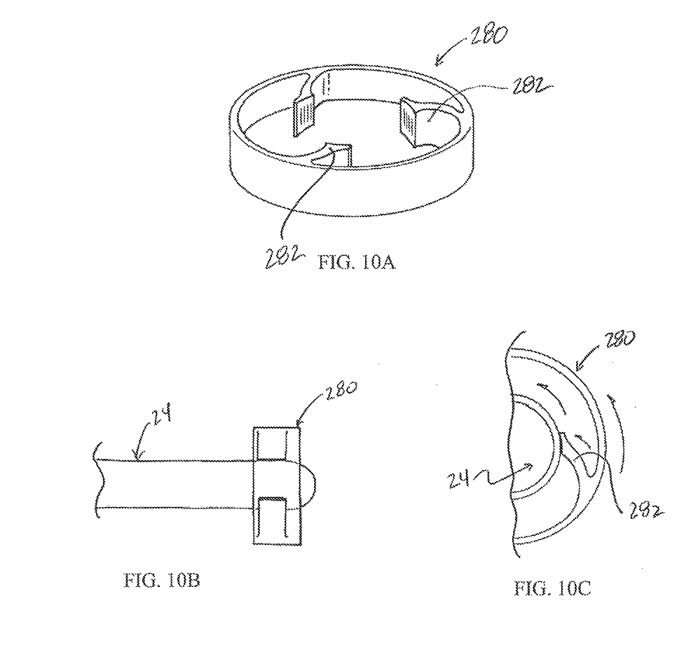

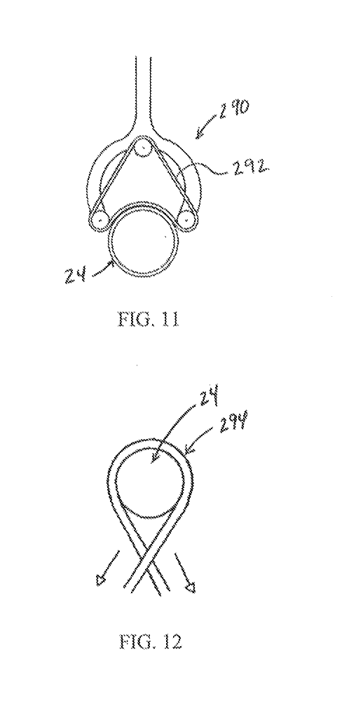

Printing units in accordance with principles of the present disclosure can incorporate other mechanical or frictional-based features differing from the rollers described above for rotatable coupling with a conventional, cylindrical specimen tube 24, such as belt grasping-type components, a drill chuck-type component, etc. For examples, a locking band 280 is shown in FIG. 10A that can be provided with the printing unit. The locking band 280 includes a two or more fingers 282 that are biased to generate a rotationally locked interface with the specimen tube 24 upon insertion of the specimen tube 24 as reflected by FIGS. 10B and 10C. This interface achieves a locked relationship when the band 280 is rotated in one direction, but will release the lock when the band 280 is rotated in an opposite direction. FIG. 11 illustrates a belt assembly 290 that can alternatively be provided with the printing unit, and includes a belt 292 that creates a frictional interface with the specimen tube 24. FIG. 12 depicts yet another optional printing unit component in the form of a winch strip 294 that is wrapped about the specimen tube 24 to achieve a rotationally locked interface.

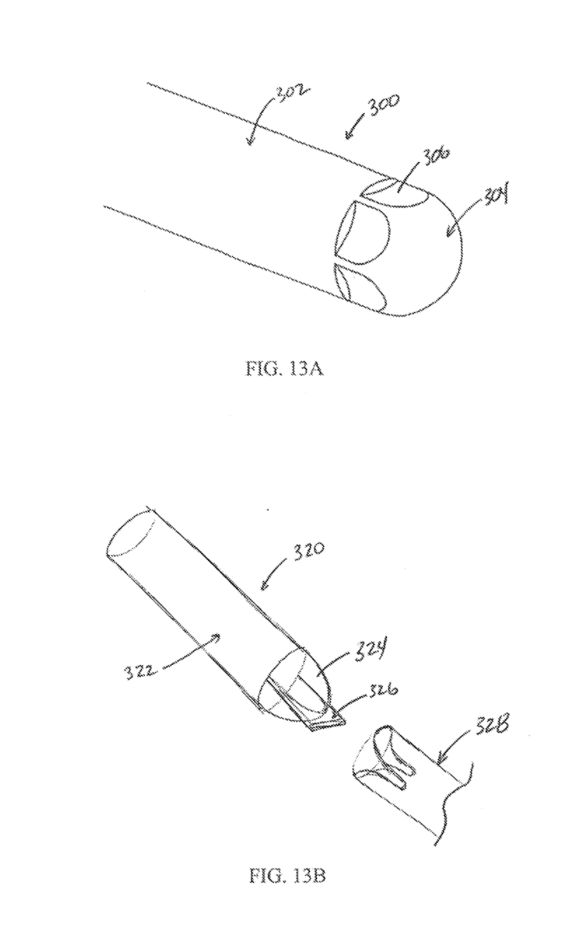

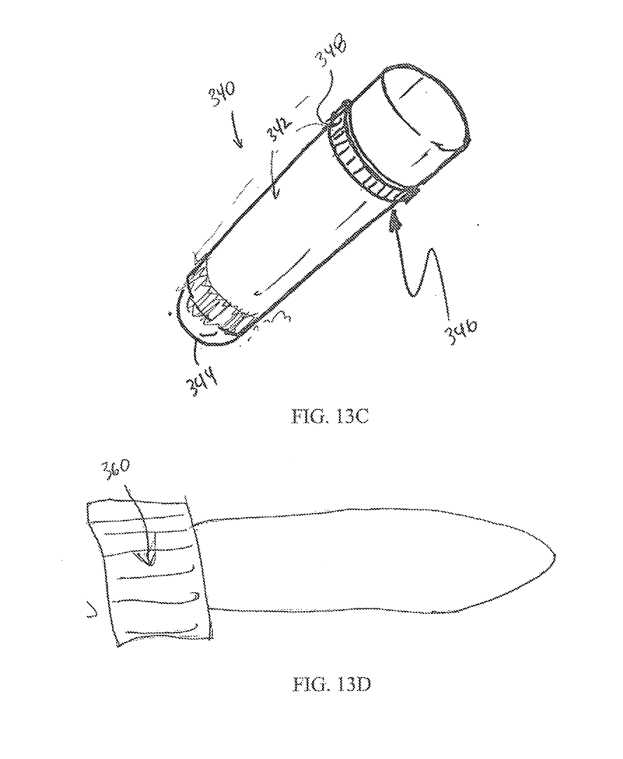

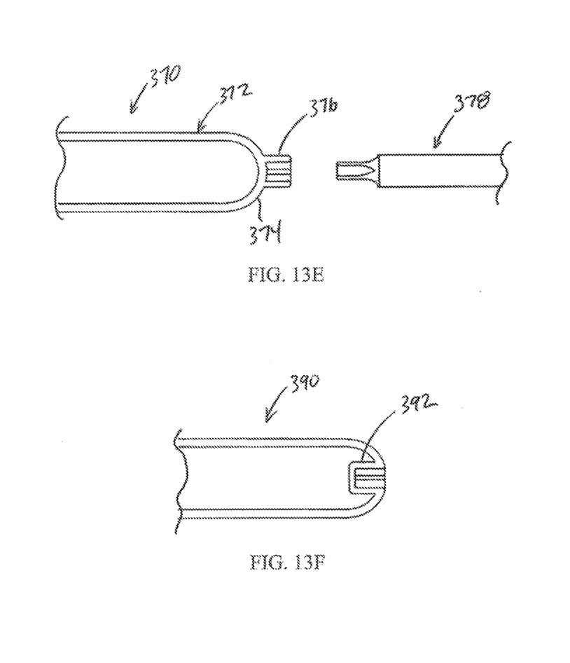

While the printing unit 200 has been described as employing one or more rollers or other components to effectuate rotation of a conventional, cylindrical specimen tube 24, in other embodiments, the specimen tube 24 can include one or more features configured to mate with corresponding components of the printing device to achieve driven rotatable coupling there between. With these constructions, the uniquely configured specimen tube can be considered part of the labeling system 20 (FIG. 1). For example, FIG. 13A illustrates a portion of an alternative specimen tube 300 in accordance with principles of the present disclosure, and in particular a tubular body 302 terminating at a close end 304. The tubular body 302 deviates from the conventional cylindrical shape adjacent the closed end 304, forming a series of flats 306 in a polygonal format. The corresponding printing unit (not shown) includes a driven socket component configured to engage the flats 306 so as to provide a direct coupling between the specimen tube 300 and the printing unit.

FIG. 13B illustrates another alternative specimen tube 320 envisioned by the present disclosure and includes a tubular body 322 terminating at a closed end 324. The tubular body 322 forms a spline 326 that extends from the closed end 324. A driven collet 328 provided with the corresponding printing unit (not shown) is configured to receive the closed end 324, engaging the spline 326. Upon insertion of the closed end 324/spline 326 into the collet 328, rotation of the collet 328 is directly transferred to the specimen tube 320, with a torque being imparted at the spline 326/collet 328 interface.

Yet another alternative specimen tube 340 in accordance with principles of the present disclosure is shown in FIG. 13C and includes a tubular body 342 terminating at a close end 344. One or more bands 346 are formed by, or attached to, the tubular body 342 and provide a series of teeth 348. The corresponding printing unit (not shown) includes gears and/or driven socket component having an internally toothed surface configured to mesh with the teeth 348 provided on the specimen tube 340 to provide a direct, rotatably driven coupling there between. FIG. 13D provides a related embodiment in which gear teeth are formed on the specimen tube cap 360. Portions of another embodiment specimen tube 370 are shown in FIG. 13E, and includes a tubular body 372 terminating in a closed end 374. A socket 376 projects outwardly from the closed end 374 and forms internal flats. A spindle 378 provided with the corresponding printing unit (not shown) includes a working end 380 configured to mate within the socket 376. The specimen tube 390 of FIG. 13F also includes a socket 392, but forms the socket 392 as in inward projection. In yet other embodiments, the specimen tubes of the present disclosure can incorporate other mechanical features for rotatably coupling with a corresponding printer unit component, such as a hexagonal (or other polygonal) shape, one or more tabs, a socket, splines, etc.

The systems and methods of the present disclosure, and in particular the specimen tube labeling devices, provide a marked improvement over previous designs. Specimen tubes with consistently applied labels displaying correct information in a desired format are quickly generated by a caregiver. Patient information and desired ancillary information can be electronically obtained from readily available machine readable protocols, parsed, and then printed on to the specimen tube using only the labeling device. Further, any desired information can be transferred between the labeling device and other caregiver terminals, such as HIS and LIS servers.

While the printing units have been described as employing a direct thermal printer, other printing techniques (and corresponding components) can also be used. For example, hand-held specimen tube labeling devices of the present disclosure can incorporate a thermal transfer printer, a laser/toner based printer, a laser non-contact printer, etc.

Patient information can be obtained by the unit through various techniques, including the scanning of machine readable indicia (e.g., barcodes, RFID tags, magnetic stripes, etc.) as described above. Alternatively, a caregiver can visually read information from the article carried by the patient (e.g., the wristband) and manually enter the information into the hand-held specimen tube labeling unit. Further, biometric scanning (e.g., finger print, retinal scan, etc.) can be employed, with the so-obtained biometric information being compared to a patient database (with the original association of the biometric data and the patient database occurring at the time of admission or other time prior to specimen collection).

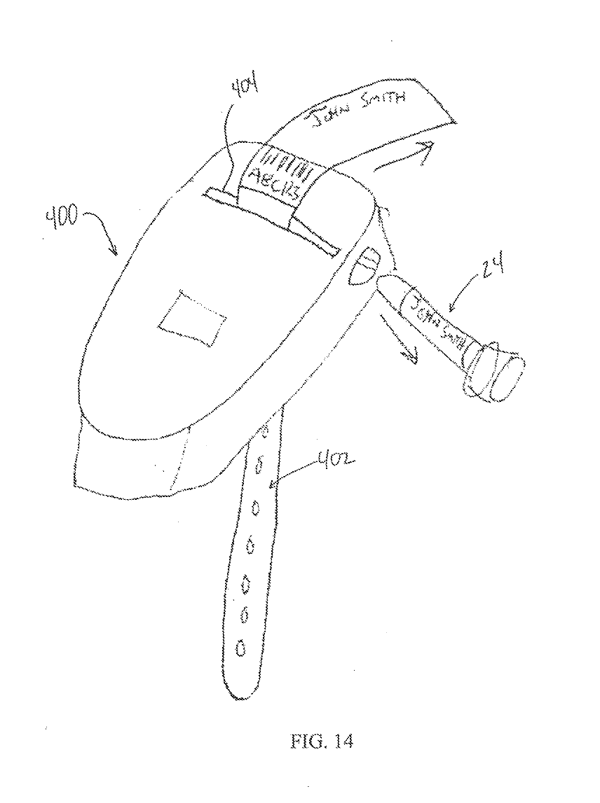

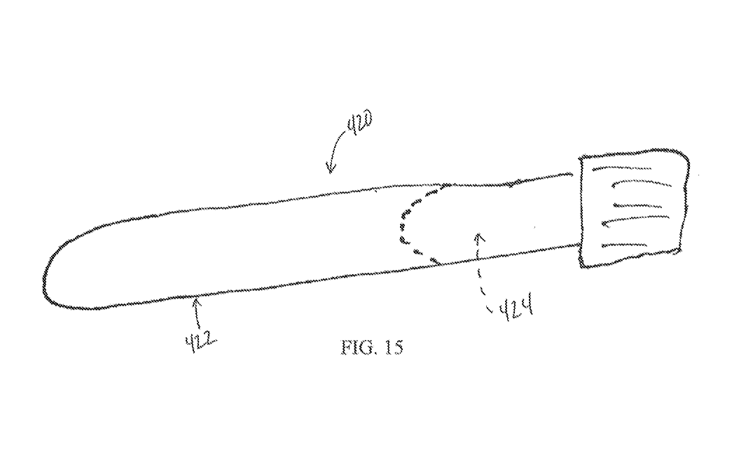

In addition to printing information on to the specimen tube/label, labeling devices and related method of use of the present disclosure can further be configured to print information on to ancillary items such as standalone labels, wristbands, tags, etc. For example, FIG. 14 illustrates a labeling device 400 configured to print onto a wristband (or label) 402 as well as the specimen tube 24. The device 400 forms a slot 404 sized to receive the wristband 402. In addition to printing information, the device 400 can be configured to program an RFID chip (or other data transport mechanism) provided with the wristband 402. The so-printed information can include the patient and ancillary information described above, as well as other information such as a unique identifier. Similarly, labeling devices of the present disclosure can be configured to print information on to a specimen tube label that is only partially attached to the tube (e.g., the specimen tube label forms a flag or flap extending outwardly from the tube that can be inserted into the slot 404 mentioned above).

The specimen tube labeling devices of the present disclosure can be configured to print information on to the specimen tube/label differing from the patient and ancillary information described above. For example, the printed information can include a listing of the necessary subsequent testing of the contained sample. Further, the labeling device can be configured to print a barcode/optical symbology representing the same patient and ancillary information. In related embodiments, the labeling device can be configured to program an RFID chip (or other data transport mechanism) embedded with the specimen tube with the same information.

In some embodiments, the specimen tube label (prior to printing) can provide an indication as to compatibility with the specimen tube labeling device. For example, the pre-printed label can include an optical pattern or barcode that is scanned by the device for the compatibility determination. Alternatively, the specimen tube can carry an RFID tag that can be scanned by the device. Even further, the device can detect the presence of UV excited ink on the specimen tube label as an indication of specimen tube/label compatibility. Other information that can be utilized by the systems of the present disclosure includes designations of the tube type inserted into the labeling device. The labeling device can compare this tube type information against a networked database to ensure the proper specimen tube type (and chemical additives therein) is being utilized for a particular test and specimen collection request. Similarly, the labeling device can be configured to print the tube type identifier on the specimen tube label for later tamper evidence detection by a user. For example, if the printed tube type identifier on a label is “RED TOP” and is found applied to a Blue top-type specimen tube, the user will quickly recognize a possible problem and investigate. As a point of reference, the tube colors mentioned above are commonly used to indicate the chemical additives contained within the specimen tube, as well as the intended testing to be performed.

In some embodiments, the specimen tube labeling device can be networked with one or more terminals utilized by the caregiver as described above. As part of this networked communication link, the labeling device can be operated to retrieve data of interest, such as what specimen tube types and quantities need to be drawn by a caregiver otherwise operating the particular device. In related embodiments, data can be synchronized back to the caregiver terminal (e.g., HIS server) to show or confirm that a particular work order to draw samples for certain specimen tubes has been completed or closed out.

In yet other embodiments of the specimen tube labeling device of the present disclosure, the device includes a sensor for detecting presence (or absence) of blood (or other patient sample) within the specimen tube prior to printing. This feature may be beneficial to prevent undue energy being applied to potentially sensitive sample materials during a subsequent printing operation.

Another optional feature provided with specimen tube labeling devices of the present disclosure is the ability to print on a shrink wrap sleeve (as opposed to a label) provided with the specimen tube. In related embodiments, the device can be configured to apply the shrink wrap sleeve to the specimen tube.

With embodiments in which the labeling device is configured to interface with a range of conventionally-sized specimen tubes otherwise employed for adult specimen collection, alternative systems of the present disclosure can optionally include a specimen tube adapted for pediatric/neonatal sample collection, such as the specimen tube 420 depicted in FIG. 15. The pediatric/neonatal specimen tube 420 includes a tubular body 422 having an external size or footprint commensurate with adult specimen tubes (and thus readily handled by the printing unit), but a reduced-sized internal reservoir 424 for containing the smaller volume pediatric/neonatal sample.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein.

What is claimed is:

1. A system for labeling a patient specimen tube with identification information, the system comprising:
a labeling device for printing information on a specimen tube, the device including:
a scanning unit configured to electronically read machine readable patient identification information provided on a patient identification article carried by the patient,
a printing unit including a print head for printing information onto the specimen tube when disposed proximate the print head, and
a microcomputer electronically connected to the scanning unit and the printing unit, the microcomputer programmed to:
receive the patient identification information from the scanning unit,
interface with a database to correlate the received patient identification information with patient label information,
format the patient label information for printing onto the specimen tube,
prompt the printing unit to print the patient label information onto the specimen tube.

2. The system of claim 1, wherein the microcomputer is further programmed to print at least a portion of the received patient identification information onto the specimen tube in conjunction with the patient label information.

3. The system of claim 1, further comprising:
a network server maintaining the database;
wherein the microcomputer is programmed to electronically interface with the network server to retrieve the patient label information from the network server.

4. The system of claim 3, wherein the network server includes at least one of a hospital information system server and a laboratory information system server.

5. The system of claim 3, wherein the labeling device is configured to wirelessly interface with the network server.

6. The system of claim 3, wherein the machine readable patient identification information is a barcode embodying unique code assigned to the patient.

7. The system of claim 6, wherein the microcomputer and the network server are configured such that the microcomputer signals the unique code to the network server and the network server retrieves the patient label information from a stored database assigned to the unique code.

8. The system of claim 3, wherein the microcomputer is further programmed to signal confirmation information to the network server upon completion of a specimen tube labeling operation.

9. The system of claim 1, wherein the scanning unit is further configured to electronically read machine readable ancillary information displayed on an ancillary identification article, the microcomputer further programmed to:
receive ancillary information from the scanning unit;
format the received ancillary information as ancillary label information, including relating the ancillary label information relative to the patient label information; and
prompt the printing unit to print the ancillary label information with the patient label information onto the specimen tube.

10. The system of claim 1, wherein the device further includes a case forming a receptacle sized to receive the specimen tube, the print head being located proximate the receptacle.

11. The system of claim 10, wherein the labeling device further includes a registration unit proximate the receptacle for orientating the specimen tube relative to the print head.

12. The system of claim 11, wherein the system further includes a specimen tube forming a registration feature configured to interface with the registration unit.

13. The system of claim 10, wherein the printing unit, the scanning unit, and the microcomputer are maintained within the case.

14. The system of claim 1, further comprising:
a specimen tube including:
a tube body forming an open end,
a stopper assembled to the open end,
an unprinted label applied to an exterior of the tube body,
wherein the unprinted label is a thermosensitve paper configured to change color when heated by the print head.

15. The system of claim 1, wherein the printing unit further includes:
a support assembly configured to maintain a specimen tube relative to the print head;
a pressure assembly configured to impart a force onto the specimen tube as maintained by the support assembly along a region of the specimen tube opposite the print head; and
a drive assembly configured to selectively rotate the specimen tube as maintained by support assembly relative to the print head.

16. The system of claim 15, wherein the pressure assembly includes a pressure roller.

17. A system for labeling a patient specimen tube with identification information, the system comprising:
a labeling device for printing information on a specimen tube, the device including:
a scanning unit configured to electronically read machine readable information provided on a patient identification article carried by the patient,
a printing unit including a print head for printing information onto a specimen tube disposed proximate the print head, and
a microcomputer electronically connected to the scanning unit and the printing unit, the microcomputer programmed to:
receive the information from the scanning unit,
prompt the printing unit to print only the received information onto the specimen tube.

18. A method for printing information on a patient specimen tube, the method comprising:
operating a labeling device to electronically read machine readable patient identification information provided on a patient information article carried by the patient;
interfacing with a database to correlate the read patient identification information with patient label information;
formatting the patient label information for printing onto the specimen tube;
loading the specimen tube into the labeling device; and
operating the labeling device to print the patient label information onto the specimen tube.

19. The method of claim 18, wherein the step of interfacing with a database to correlate the read patient identification information includes:
operating the labeling device to electronically communicate with a network server maintaining the database.

20. The method of claim 19, wherein the step of interfacing further includes:
signaling the read patient identification information to the network server; and
identifying the database in a memory of the network server based upon the patient identification information.

21. The method of claim 18, wherein the patient information article is a wristband secured to the patient.

22. The method of claim 18, wherein prior to the step of loading the specimen tube into the labeling device, the specimen tube includes an unprinted label, and the stop of operating the label device to print the patient label information includes printing the patient label information on to the unprinted label.

23. The method of claim 18, further comprising:
operating the labeling device to electronically signal a confirmation message to a network server following the step of operating the labeling device to print the patient label information onto the specimen tube.
